(19) United States
(12) Patent Application Publication
(10) Pub. No.: US 2007/0053738 A1
(43) Pub. Date: Mar. 8, 2007

(54) Writing instrument, in particular a roller ball pen comprising an information support

(76) Inventor: Niels Raeder, Munich (DE)

Correspondence Address: JACOBSON HOLMAN PLLC, 400 SEVENTH STREET N.W., SUITE 600, WASHINGTON, DC, 20004, US

(21) Appl. No.: 10/575,623

(22) PCT Filed: Oct. 14, 2004
(86) PCT No.: PCT/DE04/02281

§ 371 Date: Jul. 13, 2006

(30) Foreign Application Priority Data
Oct. 14, 2003 (DE) 103 47 688.1

(51) Int. Cl. B43K 29/00; B43K 5/12

(52) U.S. Cl. 401/192; 401/195

(57) ABSTRACT

The invention relates to a writing instrument, in particular a roller ball pen, comprising a housing (7), with a reservoir (2) for ink (9) and a writing head (4), with a writing tip (5), whereby ink (9) from the reservoir (2) may be supplied to the writing tip (5) for drawing or writing. An information support (3) is arranged in the reservoir (2) in such a manner that the ink (9) provided in the reservoir (2) firstly covers the information on the information support (3) which becomes visible on gradual use of the ink (9).

The invention relates to a writing instrument, in particular, a roller ball pen, comprising an information support according to the preamble of claim 1.

Writing instruments of this type are known especially in the form of the so-called roller ball pens. In a housing, they comprise a reservoir for liquid ink or a similar liquid dye, wherein the reservoir is connected to a writing head, using which the ink or the dye is released for the purpose of writing or drawing.

The object of the present invention is to substantially improve the acceptance of such a writing instrument among consumers.

This object is attained by a writing instrument having the features specified in claim 1.

The essential advantage of the present invention is that the acceptance and usability, especially of disposable writing instruments is substantially increased by the fact that an information support, which is arranged in the ink reservoir or the dye reservoir of the inventive writing instrument and which contains, for example advertising texts, sayings, images or numbers, e.g., lot numbers, becomes gradually visible during the consumption of the ink or the like. Therefore, the information provided on the information support remains at first hidden to the user at the time of the purchase of the writing instrument, since this information is covered by the ink and is invisible. The interest of the user is aroused by the fact that this information, which is initially hidden from him, is gradually made noticeable and visible only during the use of the writing instrument. The possible applications of the present writing instrument, for example, for advertising purposes, are advantageously increased substantially.

According to another advantage of the invention, the present writing instrument can be manufactured relatively easily, since it substantially corresponds to the corresponding known writing instruments, wherein an information support is fixed only in the reservoir in such a way that said information support is initially completely hidden by the ink or the like. Essential changes and/or modifications of the writing instrument itself are not necessary.

The invention and the embodiments thereof are explained in more detail in the following in conjunction with the figures. The figures illustrate:

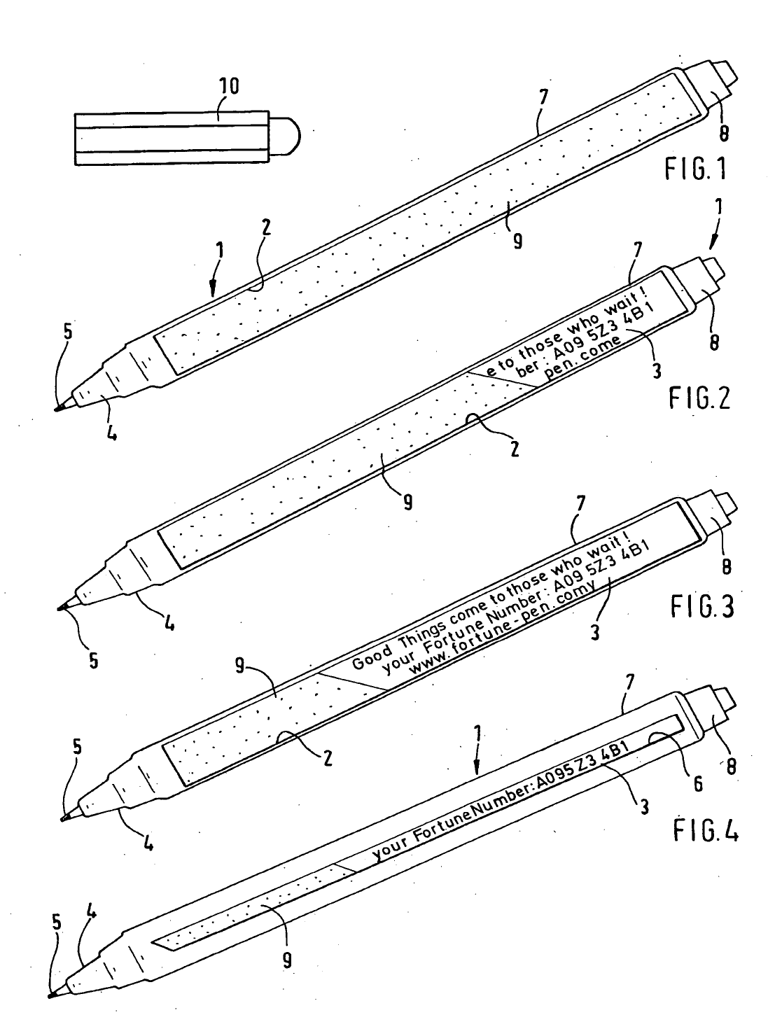

FIG. 1 an inventive writing instrument, the reservoir of which is completely filled with ink;

FIG. 2 the writing instrument shown in FIG. 1, wherein the ink is partly consumed and the information on the information support is partly visible;

FIG. 3 the inventive writing instrument, wherein the ink is used up to the extent that the information on the information support is completely visible; and

FIG. 4 an improved configuration of the invention.

According to FIG. 1, the present writing instrument 1, which is preferably a disposable writing instrument, particularly a so-called roller ball pen, is made of a housing 7, which comprises an ink reservoir 2 and is sealed on one side by a writing head 4 and by a stopper 8 on the other, as is known per se. The ink 9 contained in the reservoir 2 flows to the writing head 4 and is applied from there using a writing tip 5 or the like onto a paper or another medium for the purpose of writing or drawing.

It should be pointed out that the term “ink” is meant to connote any colored liquid, which is suitable for writing or painting and/or drawing.

The writing head 4 can be closed using a cap 10, as is known.

According to the present invention, an information support 3 is arranged in the reservoir 2, wherein said information support preferably has the form of a plastic disk or a plastic strip fixed slightly centrally in the reservoir 2 with the help of holding devices (not illustrated in detail), wherein information is imprinted on said plastic disk or plastic strip as can be seen in the figure. However, the information support can also be made of other materials, for example, of metal.

The ink 9 present in the reservoir 2 is coordinated and/or colored according to the information provided on the information support 3 in such a way that the information becomes noticeable only when the ink 9 is gradually consumed during the use of the writing instrument 1. In order for the information support 3 and/or the information present thereon to become visible, the housing 7 is made to be transparent, e.g., from a transparent plastic material. Alternatively, if said housing 7 is not made of such a transparent material, it comprises a window 6, which gradually releases the view of the information support 3 as the ink 9 is consumed, as illustrated in FIG. 4.

FIG. 1 illustrates the writing instrument 1 in a state, in which the reservoir 2 is completely filled with ink 9. FIG. 2 illustrates the writing instrument 1 in a state, in which the information of the information support 3 is partly visible since the ink 9 is already consumed partly. In the illustration of FIG. 3, the ink 9 is consumed to the extent that the information of the information support 3 is completely visible.

It is also feasible to superimpose or to imprint the information on an underlay, for example, on a paper or a film etc. and to fix, or preferably glue this underlay onto the information support 3. Furthermore, in an especially simplified embodiment, the information support can be formed by an area of the inner wall of the housing 7.

1. Writing instrument comprising a housing (7) with a reservoir (2) for ink (9) or a liquid dye and a writing head (4) with a writing tip (5), wherein ink (9) from the reservoir (2) can be supplied to the writing tip (5) for drawing or writing, said writing instrument being characterized in that an information support (3) is arranged in the reservoir (2) in such a way that the ink (9) present in the reservoir (2) initially hides the information on the information support (3), as a result of which said information becomes visible only on the gradual use of the ink (9).

2. Writing instrument according to claim 1, characterized in that the housing (3) is made of a transparent plastic material.

3. Writing instrument according to claim 1, characterized in that the housing (7) comprises a window (6), which gradually reveals a view of the information support (3) as the ink (9) is consumed.

4. Writing instrument according to claim 1, characterized in that the information support (3) has the form of a part, which is held in the reservoir (2) with the help of holding devices.

5. Writing instrument according to claim 4, characterized in that the part is made of plastic.

6. Writing instrument according to claim 4, characterized in that the part has the shape of a disk or a strip.

7. Writing instrument according to claim 1, characterized in that it is a disposable writing instrument, preferably a roller ball pen.

8. Writing instrument according to claim 1, characterized in that the information is imprinted on the information support (3).

9. Writing instrument according to claim 1, characterized in that the information is provided, preferably imprinted on an underlay, which is fixed, preferably glued onto the information support (3).

10. Writing instrument according to claim 9, characterized in that the underlay is a paper or a film.

11. Writing instrument according to claim 1, characterized in that the information is an image, an advertising text, an inscription, a lot number or the like.

12. Writing instrument according to claim 1, characterized in that the color of the information and/or of the information support (3) is coordinated with the coloring of the ink (9).
